(19) United States
(12) Patent Application Publication
(10) Pub. No.: US 2023/0073198 A1
(43) Pub. Date: Mar. 9, 2023

(54) System and Method for Farming and Harvesting Floating Seaweed and Floating Aquatic Plants

(71) Applicant: OceanAg, Inc., Houston, TX (US)

(72) Inventors: Samuel P. Walker, Houston, TX (US); William Thomas McBarnet, Montgomery, TX (US)

(73) Assignee: OceanAg, Inc., Houston, TX (US)

(21) Appl. No.: 17/940,330

(22) Filed: Sep. 8, 2022

Related U.S. Application Data
(60) Provisional application No. 63/241,584, filed on Sep. 8, 2021.

(51) Int. Cl. A01G 33/00; A01D 44/00

(52) U.S. Cl. CPC A01G 33/00; A01D 44/00

(57) ABSTRACT

A floating seaweed and floating aquatic plant farming system includes an enclosed area positioned in a water body. The enclosed area is defined by one or more floating booms each including an attached mesh skirt. The system also includes a harvesting system for collecting seaweed growth in the floating enclosed area. The harvesting system is static or dynamic in relation to the floating enclosed area. The system may also include a processing system on a vessel containing the harvesting system. The one or more floating booms are secured in a location in the water body with an anchor system or with pilings. Alternatively, the enclosed area is defined by one or more mesh panels each secured to, and extending across spaces between, pilings. The seaweed is grown within the enclosed area and harvested by the harvesting system.

### CROSS-REFERENCE TO RELATED APPLICATION

The application claims the benefit of and priority to U.S. Provisional Pat. Application No. 63/241,584 filed on Sep. 8, 2021, which is incorporated herein by reference in its entirety.

### BACKGROUND OF THE INVENTION

Various floating seaweed species, including Sargassum ƒluitans and Sargassum natans, are commercially valuable for use in a variety of products from crop fertilizer to building materials. The current practice is to gather wild floating seaweed in both coastal ocean areas or on beaches where the seaweed has washed up. Disadvantageously, this process does not provide a stable supply of seaweed because it is reliant on the unpredictable occurrence of wild floating seaweed washing up. Additionally, the seaweed collected this way often has poor quality because it atrophies quickly upon washing onto a beach. The seaweed harvested this way could have also drifted through areas with significant pollution, which may be bioaccumulated by the seaweed, and areas with significant floating plastic or other garbage, which must be separated from the seaweed after collection. The success of commercial products using such floating seaweed has been limited due to the lack of a stable, quality supply from the wild seaweed species.

Excess nutrients in natural water bodies cause significant issues with marine life. For example, human activities in urban and agricultural areas throughout the Mississippi River watershed lead to excess nutrients flowing into the Gulf of Mexico. Fertilizers are believed to significantly contribute to excess nutrient levels. The excess nutrients in the water stimulate an overgrowth of algae that die and sink to the bottom. This algal decomposition removes oxygen from the water column and leads to dead zones in the Gulf of Mexico. The water in the dead zones contain insufficient oxygen levels to support marine line. Another example of excess nutrients in water bodies is Lake Okeechobee in Florida. The water in this lake contains high levels of phosphorus and other nutrients from surrounding agriculture and development, which lead to increased frequency of harmful algal blooms and dominance of blue-green algae that are harmful for both aquatic life and human health.

A need exists for a predictable, efficient, and cost-effective method of farming and harvesting floating seaweed and floating aquatic plants. A need also exists for a method of better understanding and controlling the quality of seaweed that is harvested. Finally, a need exists for reducing the excess nutrient levels in certain natural water bodies to prevent the occurrence of dead zones and toxic algal blooms.

### SUMMARY OF THE INVENTION

A system for farming and harvesting floating seaweed and other floating aquatic plants. The floating seaweed farming system includes an enclosed area defined by floating booms with mesh skirts positioned in a natural or artificial water body. The floating booms may be immobilized by anchoring to the floor or lower surface of the water body. Alternatively, the floating booms may be immobilized by being secured to pilings set in the bed of the water body. In other embodiments, the enclosed area is defined by one or more mesh fences each secured to two or more pilings, with the mesh fences extending across spaces between pilings. The floating seaweed farming system’s enclosed area may form any shape, such as square, rectangle, or triangle. The seaweed farming system may use a static harvesting system or a dynamic harvesting system. The seaweed farming system may be positioned in a nutrient rich area to maximize seaweed growth rate and reduce the nutrient overload. By providing a fixed and enclosed area for farming the seaweed, a large, stable supply of seaweed is achieved and the quality of the seaweed is traceable to a defined location for better pollution management and quality control. The enclosure prevents floating plastic or other garbage from becoming entangled in the seaweed and fouling the harvest.

Some embodiments of the floating seaweed farming system use static harvesting methods. In these embodiments, one or more static harvesting receptacles may be defined by breaks or openings in the enclosed farming area. Seaweed has a high natural growth rate (e.g., up to 5% growth per day for sargassum species). As the seaweed grows within the area enclosed by the floating booms and mesh, the seaweed crop presses against the booms and mesh, which exert pressure on the seaweed, thereby forcing the seaweed crop to move toward the static harvesting receptacles located on the perimeter or within the enclosed area. The only clear area of water in the enclosed area for the growing seaweed to move is the area adjacent to the harvesting receptacle where seaweed was recently harvested. In this way, the static harvesting system causes the seaweed crop to essentially migrate toward the static harvesting receptacles. Because of seaweed’s high growth rate and the absence of a need to physically move the harvester, this static seaweed farming and harvesting system is highly energy efficient. Besides the natural pressure of the growth of the seaweed against the floating booms and mesh pushing the seaweed toward the static harvester, wind and water currents can also aid in moving the seaweed crop toward the static harvester.

Other embodiments of the floating seaweed farming system use dynamic harvesting methods. For example, a harvesting device may travel within the enclosed area to harvest the seaweed crop. Alternatively, a harvesting device may travel in an area surrounding the enclosed area in order to position a harvesting extension in different positions within the enclosed area.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages in accordance with the present invention:

FIG. 1 is a top schematic view of a floating seaweed farming system.

FIG. 2 is a side schematic view of a floating seaweed farming system secured in place with an anchor system.

FIG. 3 is a side view of a floating seaweed farming system including floating booms with mesh skirts, which are secured in place with pilings.

FIG. 4 is a schematic side view of an alternate floating seaweed farming system including only mesh fencing or panels secured in place with pilings.

FIGS. 5A - 5J, 6A - 6H, 7A - 7C, 8A - 8I are schematic views of numerous enclosure shapes of the floating seaweed farming systems disclosed herein.

FIG. 9 is a top schematic view of a floating seaweed farming system with a static harvesting system.

FIG. 10 is a side schematic view of a conveyor belt of the static harvesting system shown in FIG. 9.

FIG. 11 is a side schematic view of an enclosure of the floating seaweed farming system shown in FIG. 9.

FIG. 12 is a side schematic view of an alternate floating seaweed farming system with a static harvesting system.

FIG. 13 is a side schematic view of an enclosure of the alternate floating seaweed farming system shown in FIG. 12.

FIG. 14 is a schematic side view of another alternate floating seaweed farming system with a static harvesting system.

FIG. 15 is a schematic side view of the floating seaweed farming and harvesting system shown in FIG. 10 in a storm position in which the harvesting equipment, processing equipment, and floating boom/mesh may be raised high above the water level on pilings.

FIG. 16 is a schematic top view of a floating seaweed farming system with a dynamic harvesting system including a harvesting device positioned within the enclosed area and configured to be pulled along a cable, rail, rope, or chain attached to pilings.

FIG. 17 is a schematic top view of a floating seaweed farming system with more than one dynamic harvesting system.

FIG. 18 is a schematic top view of a floating seaweed farming system with a dynamic harvesting system including a harvesting device positioned outside of the enclosed area and configured to be pulled along a cable, rail, rope, or chain attached to pilings.

FIG. 19 is a schematic top view of a floating seaweed farming system with a dynamic harvesting system with independently mobile harvesting devices positioned within the enclosed area and stations for renewable energy charging and seaweed offloading and processing, which are positioned high above the water level on pilings.

FIG. 20 is a schematic side view of a station shown in FIG. 19.

### DETAILED DESCRIPTION OF SELECTED EMBODIMENTS

Detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. Various embodiments of the present invention are described herein. To avoid redundancy, repetitive description of similar features may not be made in some circumstances.

Disclosed herein are various embodiments of systems and methods of farming, harvesting, and processing seaweed, algae, and other floating aquatic plants, such as saltwater sargassum seaweed, freshwater aquatic macrophytes (e.g., American frog’s bit and giant duckweed), and any other species of floating seaweed or floating aquatic plants. “Seaweed” as used herein means any floating species of aquatic plant, seaweed, or algae that is capable of being contained within a boom with mesh skirt or mesh fence, mesh, or any other enclosure at a water surface. Various embodiments may be used depending upon several factors, including water depth (e.g., shallow to deep water), water type (e.g., saltwater, brackish, freshwater), use of pilings or anchors, and floating plant or seaweed species.

The seaweed farming system includes an enclosed area defined by one or more floating booms with attached mesh skirts. In some embodiments, the mesh skirt attached to the floating boom has a small mesh size to allow water flow while preventing marine animal entanglement. In other embodiments, the enclosed area is defined by one or more mesh panels or fences secured to pilings in calm water bodies that experience insignificant water level changes. The floating booms and mesh enclosure mechanisms are cost effective. They allow constant nutrient replenishment through the mesh, while ensuring that the seaweed crop does not drift away and preventing floating garbage from becoming entangled in the seaweed crop. A single enclosed area defined by the floating booms or the mesh fencing may be in the range of 10 square meters to 1,000 square kilometers. A number of these enclosed areas may form a floating seaweed farm with ample space between enclosed areas to enable vessel navigation.

In some embodiments, anchors with ropes or chains may be used to secure the floating seaweed farming system in a location. For example, a Danforth anchor with a rope may be used to anchor the floating boom and skirt enclosure, thereby immobilizing the enclosed area. Anchors may be used in deeper water locations. The anchors may be secured to a floor of the water body. Alternatively, if the floating seaweed farming system is positioned within a water body in a location close to shore or land, the floating seaweed farming system may be secured in the location using anchor lines attached to anchors set in the ground on the shore or land or attached to posts on shore or land.

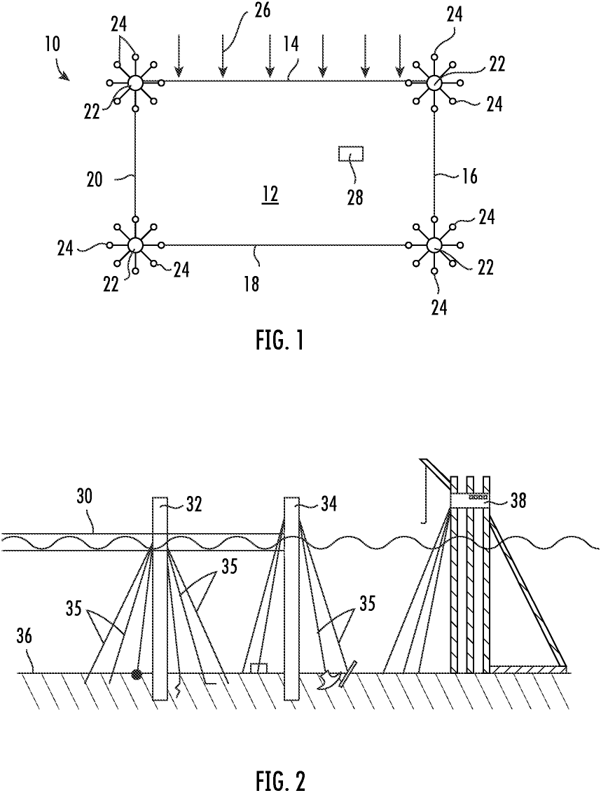

With reference to FIG. 1, seaweed farming system 10 includes enclosed area 12 defined by floating booms 14, 16, 18, and 20. Each of the floating booms includes an attached mesh skirt. Floating booms 14, 16, 18, and 20 may each be separate booms secured together to define enclosed area 12. Alternately, floating booms 14, 16, 18, and 20 may be integrally formed as a single continuous boom arranged to define enclosed area 12. Both ends of each floating boom are secured to fence posts 22. In one embodiment, each fence post 22 may be formed of a steel ocean fence post. Each fence post 22 is immobilized by an anchor system including more than one anchor point 24, as illustrated. In the illustrated embodiment, the floating booms may each have a length in the range of 5 km to 10 km to form a rectangular enclosure having an area of about 50 square kilometers. The enclosure may be positioned near the mouth of a river (e.g., the Mississippi River), with the mesh skirt allowing water and nutrients flowing in direction 26 from the river to flow through the enclosed area 12, thereby allowing the seaweed growing within enclosed area 12 to absorb nutrients from this water. Optionally, the enclosure may be configured to surround an abandoned platform 28 for use in harvesting, process, refining, or storing seaweed or for use as living quarters, administration, or security space.

FIG. 2 illustrates a seaweed farming system including an enclosed area defined in part by floating boom 30 secured to fence posts 32 and 34. A set of cables or chains 35 extend from each fence post to a set of anchors secured to the seabed 36. As illustrated, an abandoned oilfield rig 38 may be retrofitted to support certain components of the seaweed farming system or other components involved in the harvesting, processing, or storage of the seaweed crop grown in the seaweed farming system. Rig 38 may be retrofit to structurally support the seaweed farming system. For example, trusses or cables may be added to rig 38 to increase its strength with respect to increased horizontal forces.

In other embodiments, a more permanent structure may be used to secure the floating seaweed farming system in a location. For example, pilings formed of wood, concrete, metal, or any other durable material may be used as the attachment point for the floating boom with mesh skirt. Pilings may be used in locations with shallower water locations. In preparation for a storm (e.g., hurricane or tropical storm), the boom and attached skirt may be removed from the water while the pilings remain in the water. The boom with attached mesh skirt may be lifted out above the water surface for storms or to assist in harvesting activities, such as in the harvesting of attached biomass growth on the boom and mesh skirt.

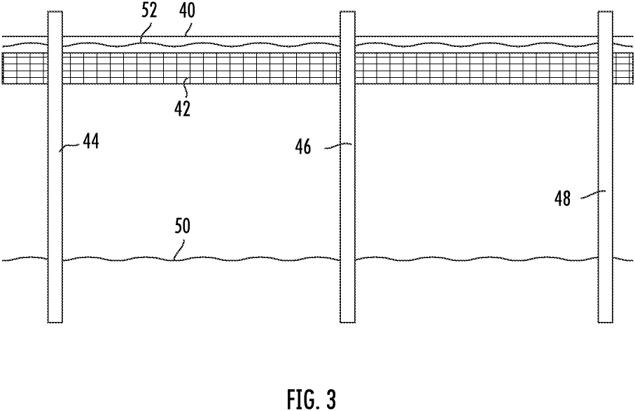

Referring to FIG. 3, a seaweed farming system may include an enclosure defined, in part, by floating boom 40 with attached mesh skirt 42. Floating boom 40 may be formed of an 8” floating boom, and mesh skirt 42 may be formed of a 3” mesh. The mesh skirt may be constructed of plastic, metal, or another durable material. Floating boom 40 may be secured to pilings 44, 46, and 48, with the floating boom with mesh skirt’s attachment to the piling having slack and dynamically allowing the boom with mesh skirt to slide up and down along the piling to allow the floating boom to continue floating at the water surface at variable water levels to retain seaweed at the water surface. The boom with mesh skirt may also be attached to the piling with a rope having a sufficient length to allow the floating boom with mesh skirt to continue floating at the water surface level as the water level changes. A lower end of each piling is secured in seabed 50 and an upper end of each piling may extend above waterline 52.

In some embodiments, the seaweed farming system’s enclosed area may be defined by one or more mesh panels or fencing each secured to two or more pilings, with the mesh panels or fencing extending across spaces between pilings. This embodiment does not include a floating boom or buoy. Instead, the pilings secure the mesh panels or fencing at the water surface, with the mesh extending above the water surface and below the water surface to ensure that the floating plants or seaweed are contained within the enclosure while allowing nutrient flow into the enclosure. This embodiment may be used in applications using pilings in water bodies that are calm (i.e., low wind speed and small waves) and have a relatively consistent water level (i.e., small water level changes over time). Examples of suitable water bodies include large lakes or reservoirs with minimal water level changes. The mesh panels or fencing may be strung and tensioned between the pilings a small distance above and extending below the water surface to keep floating seaweed within the enclosed area. The mesh panels may be wide enough to contain floating seaweed and floating plants during normal water level fluctuations. The mesh panels may be raised or lowered in the water column on the pilings in response to any unusually large water level changes to continue to contain the floating seaweed or other floating plants. In certain embodiments, the mesh panels or fencing are secured to the pilings in a configuration that allows for height adjustment of the mesh panels or fencing. For example, the mesh panels or fencing may be lifted or lowered on the pilings to ensure that the floating seaweed or other floating plants remain contained within the enclosed area when large water level changes occur.

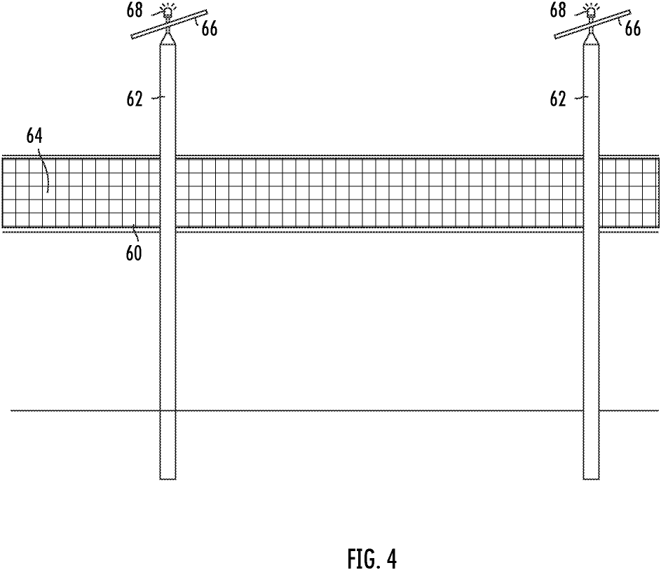

With reference to FIG. 4, a seaweed farming system may include an enclosure defined, at least in part, by mesh panel 60 secured in place by pilings 62. Mesh panel 60 may be formed as a single continuous mesh panel stretched or tensioned around multiple pilings and across the spaces separating those pilings. Alternatively, mesh panel 60 may be formed of separate mesh panels each extending between two pilings. Mesh panel 60 may be strung between pilings 62 such that water level 64 is between an upper end and a lower end of mesh panel 60, as illustrated. Solar panels 66 may be secured to one or more of pilings 62, such as at the upper end of each piling. Solar panels 66 may be configured to power lights 68 on the upper ends of pilings 62, along with any other electrical components of the seaweed farming system. Lights 68 may be used to provide a visual indication of the seaweed farming system’s location in the dark. This embodiment may be used in calm water bodies (i.e., low wind and waves) that have relatively consistent water levels such that water level 64 remains between the upper and lower ends of mesh panel 60. Mesh panel 60 may be wide enough to retain the floating seaweed with insignificant changes in water level 64. If water level 64 changes significantly, mesh panel 60 may be lifted or lowered on pilings 62 to continue retaining the floating seaweed within the enclosure. During a hurricane or other storm, mesh panel 60 may be removed from pilings 62, lifted high on pilings 62, or lowered below water level 64.

In embodiments including floating booms, the buoyancy of the floating booms enable the floating booms and mesh skirts to remain at the water surface even as water levels change. Accordingly, the floating booms do not need a height adjustment mechanism. The floating boom embodiments may be used in a variety of water bodies and wind and wave conditions. The floating boom embodiments may be used with anchor systems or with pilings. In contrast, the embodiments including only mesh panels or fencing may be used with pilings in calm water bodies that do not experience significant water level variations.

The floating seaweed farming system may be installed in an area with nutrient overloaded water (i.e., eutrophic water bodies) as a cost efficient and effective bioremediation method, thereby providing a valuable service for surrounding communities. The excess nutrients may be consumed by the floating seaweed growth within the enclosed area. The seaweed may then be harvested to remove the seaweed and the seaweed’s contained nutrients from the system, thereby removing and cleaning nutrients from the nutrient overloaded waters. Additionally, the seaweed growth will consume carbon dioxide, thereby reducing the atmospheric carbon dioxide levels and reduce climate change effects. The harvested seaweed may be used in many renewable applications, such as for crop fertilizer or livestock feed on land.

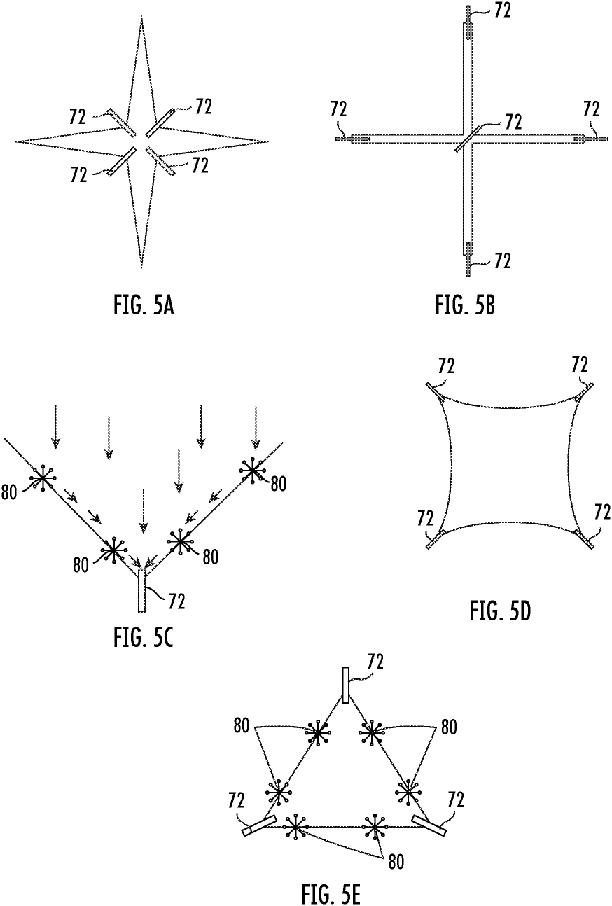

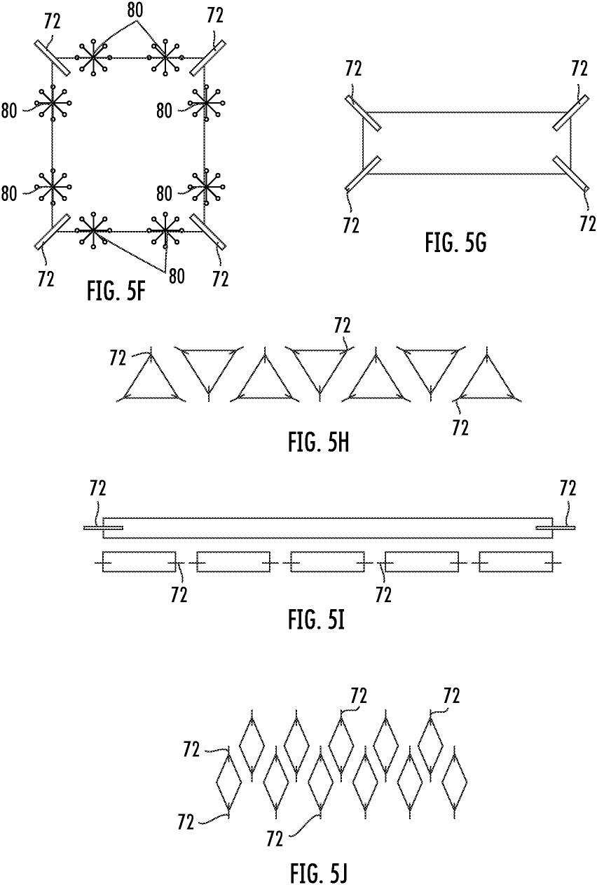

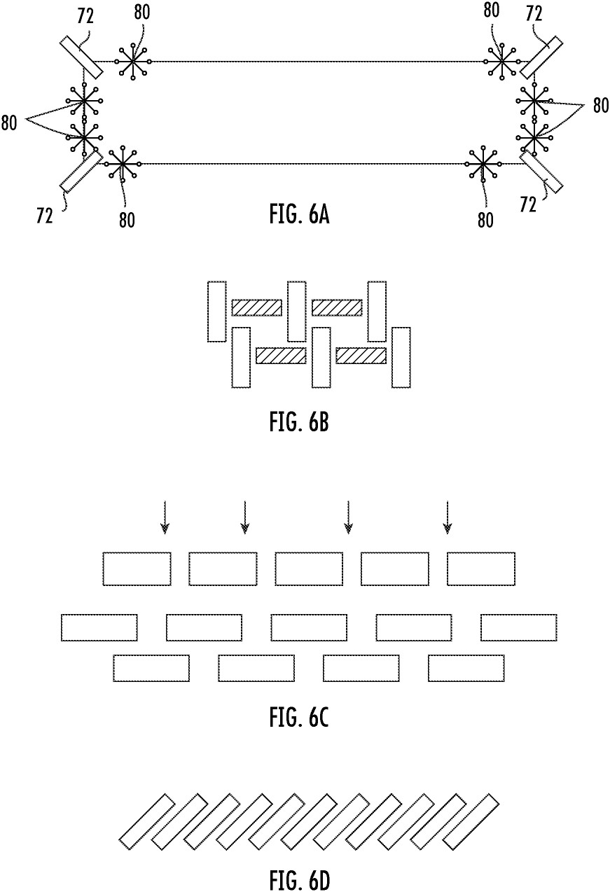

As illustrated in FIGS. 5A - 5J, 6A - 6H, 7A - 7C, and 8A - 8H, the seaweed farming system’s enclosed area may have a variety of shapes, such as stars (as shown in FIG. 5A), triangles (as shown in FIGS. 5E, 5H, and 8A - 8I), squares (as shown in FIGS. 5F and 7A -7C), rectangles (as shown in FIGS. 5G, 5I, and 6A - 6H), diamonds (as shown in FIG. 5J), V-shapes (as shown in FIG. 5C), or other shapes (as shown in FIGS. 5B and 5D). Optionally, any of the seaweed farming systems may include one or more harvester conveyor belt 72 and one or more gathering boom 80, as explained in more detail below. Configurations of multiple enclosures (e.g., a zipper-like line of interlocking triangular enclosures) may be placed at river mouths or other nutrient rich areas to maximize the flow through and capture of nutrients and growth of the seaweed biomass, while leaving numerous channels between enclosures for navigation of boats and vessels. In some embodiments, the shapes of the enclosed areas may be oriented in relation to the water current direction. For example, in FIG. 8B, the triangular enclosures may be oriented to face the current direction 69. In another embodiment shown in FIG. 8C, the triangular enclosures may be oriented to block the current flowing in direction 69. In yet another embodiment shown in FIG. 8D, the triangular enclosures may be oriented to partially block the current flowing in direction 69.

In addition to the natural flow of surrounding water through the mesh skirt of the enclosure, target water can be piped into the center of the floating boom enclosure to further facilitate biomass growth and nutrient uptake in the enclosed area. Furthermore, renewable energy resources, such as wind, solar, or hydrogen, may be used to power the pumping of the target water into the center of the floating boom enclosure.

For example, nutrient rich coastal bay water from a desired depth may be piped into the center of a floating boom with mesh skirt enclosure in a saltwater onshore pond to promote the growth of a floating seaweed or algae in the enclosure. In another embodiment, nutrient rich wastewater from an aquaculture or food manufacturing site may be piped into the center of a floating boom with mesh skirt enclosure positioned in a lake or pond for promoting the growth of freshwater floating aquatic macrophytes within the enclosure. In yet another embodiment, nutrient rich water from a greater depth may be piped up to the surface within the floating boom with mesh skirt enclosure to promote seaweed growth within the enclosure. In each of these embodiments, most of the nutrients contained in the water piped into the enclosure would be absorbed by the floating aquatic plants in the enclosure before spreading beyond the enclosure to the surrounding waters. In further embodiments, the water that is piped to the center of the enclosure may be distributed along the surface of the floating seaweed through a system of smaller pipes with distribution systems, drip systems, sprayers, or sprinklers.

Conventionally, floating boom with mesh arrangements have been used as exclusion systems intended to keep seaweed and other floating plants out of certain areas or to prevent the seaweed or other floating plants from reaching beaches or docks. This use is consistent with the prevailing view that seaweed and floating aquatic plants are pests to be kept out.

The enclosure formed by the floating boom with mesh skirt contains the seaweed crop in a predetermined farming location where nutrients/water conditions have been determined to be optimal for growth, and where other environmental conditions are optimal for floating plant/seaweed growth and survival. For example, the floating boom with attached mesh skirts keep floating seaweed/plants away from areas that are too shallow or areas where desiccation and wave action can kill the plants/seaweed or herbivores have easier access to eat or kill them.

Harvesters for the floating seaweed farming enclosures may be located on the perimeter or within the enclosures. The harvesters may be static or mobile. Harvesters may also be operated by personnel or remotely controlled. In some embodiments, the harvesters may be powered by renewable energy sources, such as solar, wind, or hydrogen. In these embodiments, the renewable energy systems may be attached to the harvester, the enclosure piling structures, or both. With its high growth rate, excess seaweed growth may be skimmed off and harvested daily. Alternatively, greater quantities of seaweed growth may be harvested at greater time intervals.

In some embodiments, static harvesters may be temporarily or permanently attached to the floating boom anchoring system or piling system. Alternatively, static harvesters may be secured on or integrated with raised jack-up vessels or anchored vessels. These vessels may be placed in areas such as the corners of the floating boom enclosure where seaweed builds up due to wind or water currents.

The floating boom enclosure for seaweed farming allows for a highly efficient static harvesting system. By creating an enclosed seaweed growth area with finite space, the floating boom and mesh forces the excess growth of the seaweed towards the static harvester area because the area in front of the harvester is the only clear water area within the enclosure. This allows a highly energy efficient and cost effective static crop harvesting system in which the seaweed crop’s excess growth moves toward the static harvester, instead of the harvester moving toward the seaweed crop.

Static harvesting devices may include conveyor belts made of metal, rubber, or any other durable material. In some embodiments, the seaweed biomass may be funneled to conveyor belts with spinning booms located on each side of the conveyor belt, at intervals along the floating enclosure boom, or both. Alternatively, the seaweed biomass may be funneled to conveyor belts by the forward movement of the harvester. The conveyor belts may have protrusions, ridges, or hooks on them to better grab and pull the seaweed onto a surface of the conveyor belt. Floating seaweed can also be harvested using excavator arms with grabbers to grab or scoop up the seaweed.

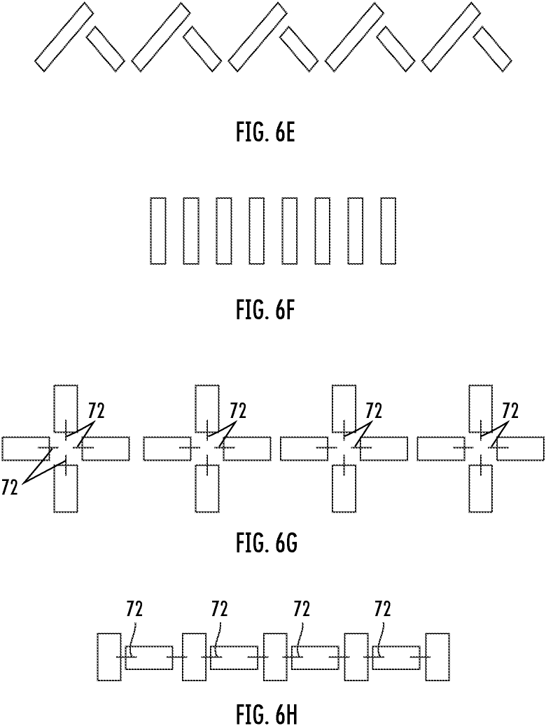

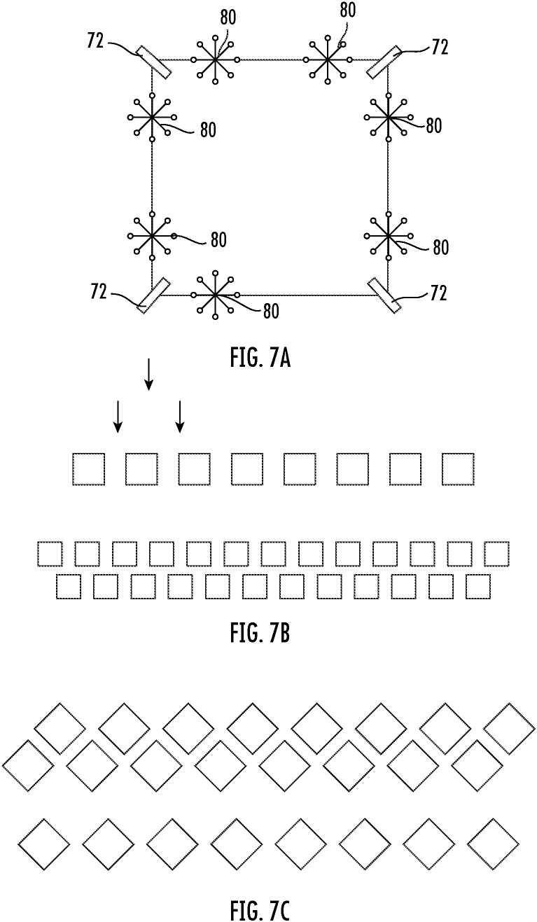

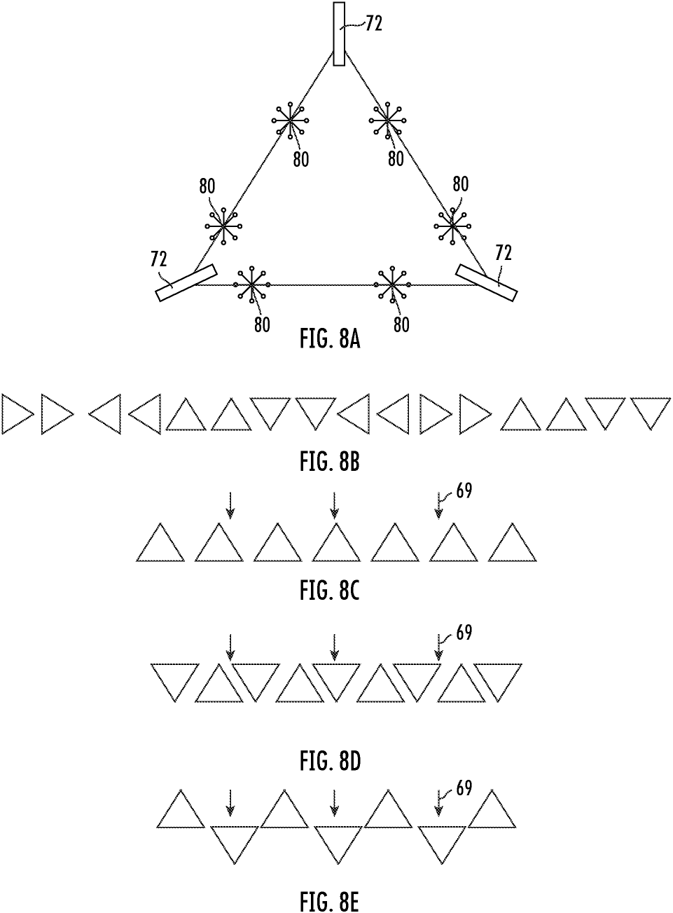

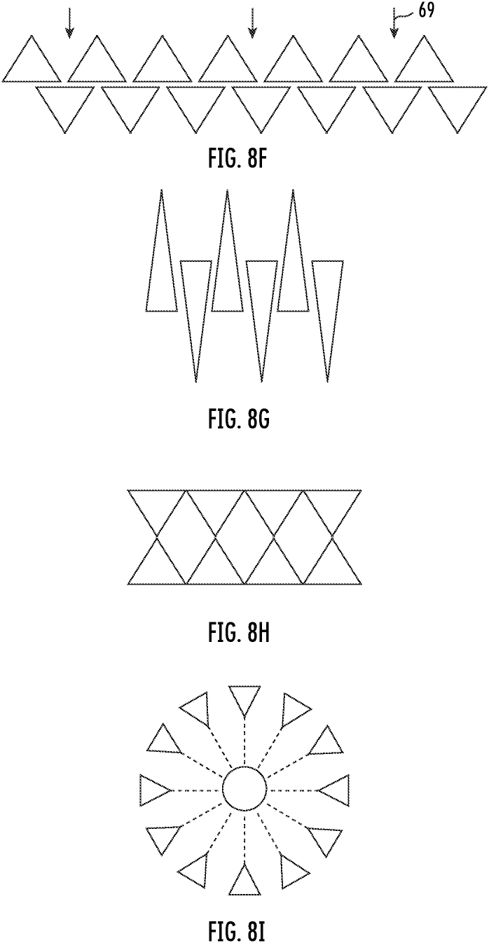

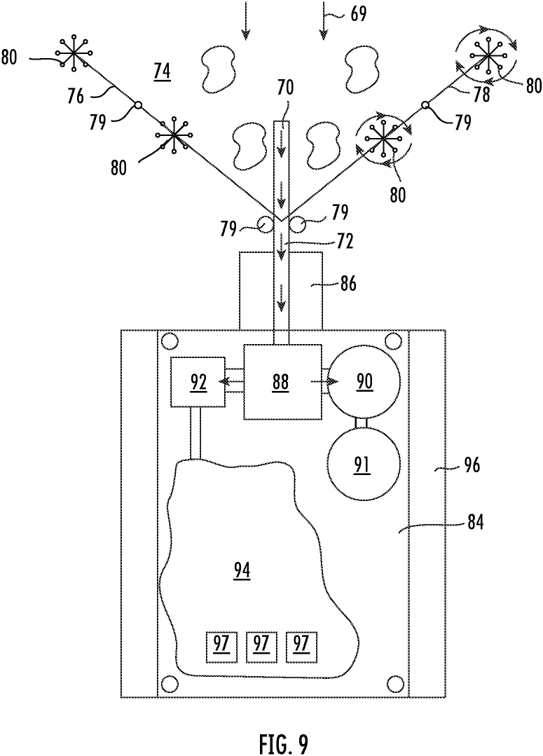

With reference to FIGS. 9 - 11, distal end 70 of conveyor belt 72 is positioned in a downstream corner of enclosure 74 of a floating seaweed farming system. Floating booms 76 and 78, which optionally has mesh skirt 77 attached thereto as shown in FIG. 11, may be secured to a series of pilings 79 to define enclosure 74. Optionally, a series of spinning booms 80, or other rotating projections, may be secured along floating booms 76 and 78. The water current 69 may push the growing seaweed toward floating booms 76 and 78, and spinning booms 80 may further direct the growing seaweed toward distal end 70 of conveyor belt 72. The conveyor belt 72 may include teeth 82 (shown in FIG. 10) to “grab” the seaweed and pull it along the conveyor belt’s surface onto processing vessel 84. For example, conveyor belt 72 may include 4” teeth. Optionally, a mirror, such as parabolic mirror 86, may be positioned below or near conveyor belt 72 to direct sunlight 87 and heat toward the seaweed on the conveyor surface to begin the process of drying the seaweed. Processing vessel 84 may include crusher 88, liquids storage container 90, liquid extract tank 91, dryer or baler 92, and dry storage area 94. The seaweed harvested by conveyor belt 72 may be fed into crusher 88, which may separate and direct liquid and solid components of the seaweed into liquids storage container 90 and dryer 92, respectively. The solid seaweed components may be dried and baled and stored on processing vessel 84. Processing vessel 84 may also include solar panels 96 configured to power the equipment on board processing vessel 84. The baler 92 may produce compressed dried bales of seaweed 97. Each bale 97 may be labeled with a tag including source data for the seaweed bale. Source data included on the tag may be a block chain algorithm output, which identifies the harvest location, harvest date, and a batch number. The traceable data can also be utilized in carbon and water quality credits that the seaweed bales and its stored carbon and nutrients represent.

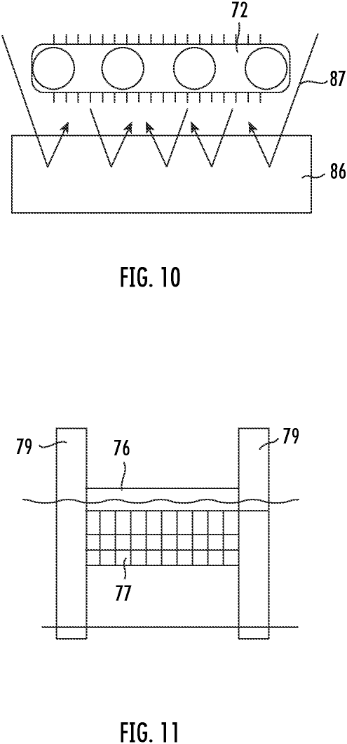

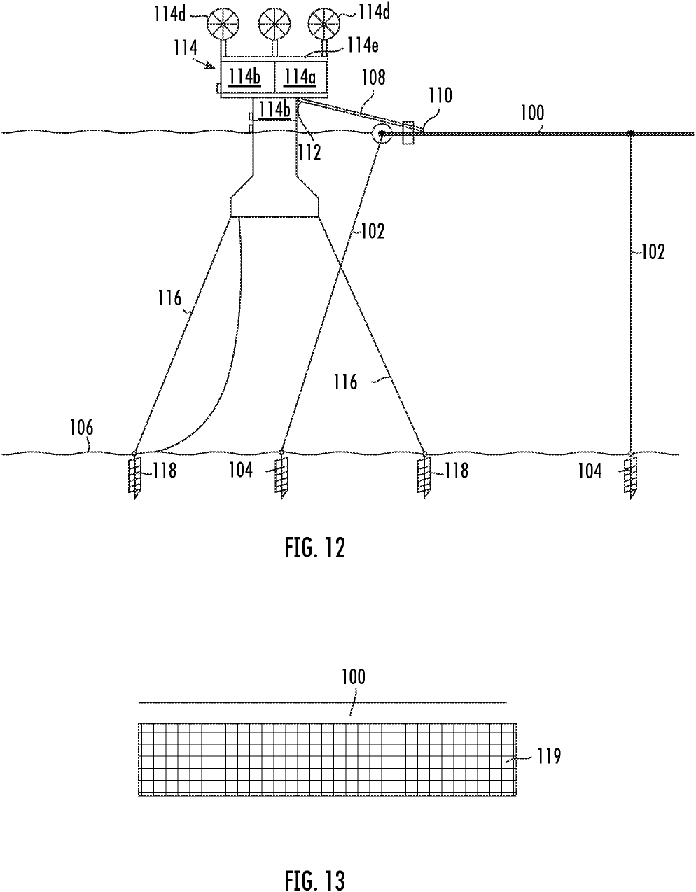

FIG. 12 illustrates another embodiment of a seaweed farming system. In this embodiment, the floating booms, including floating boom 100, are secured in the location with chains 102 and screw anchors 104 secured to the seabed 106 as illustrated. Sufficient slack is provided in the anchor line lengths to allow floating booms 100 to continue to float at the water surface with variable water levels and conditions. A static harvesting system may include conveyor belt 108 with distal end 110 disposed in the enclosed area of the seaweed farming system and with proximal end 112 secured to floating vessel 114. Floating vessel 114 may include a seaweed processing system 114a, dry storage space 114b, and liquid storage space 114c. When storage spaces 114b and 114c fill, a ship may engage with floating vessel 114 to empty the storage spaces. Alternatively, these products are hauled to market or continuously piped as liquids to market. Floating vessel 114 may also include windmills 114d and/or solar panels 114e configured to power conveyor belt 108 and processing system 114a. Floating vessel 114 may be secured in the location with chains 116 and screw anchors 118 secured to the seabed 106. Floating vessel 114 is capable of withstanding a hurricane. Prior to a hurricane, the floating boom 100 and harvesting conveyor belt 108 can both be collected and stored aboard the vessel 114 out of waves. In certain embodiments, mesh skirt 119 is attached to floating boom 100 as shown in FIG. 13.

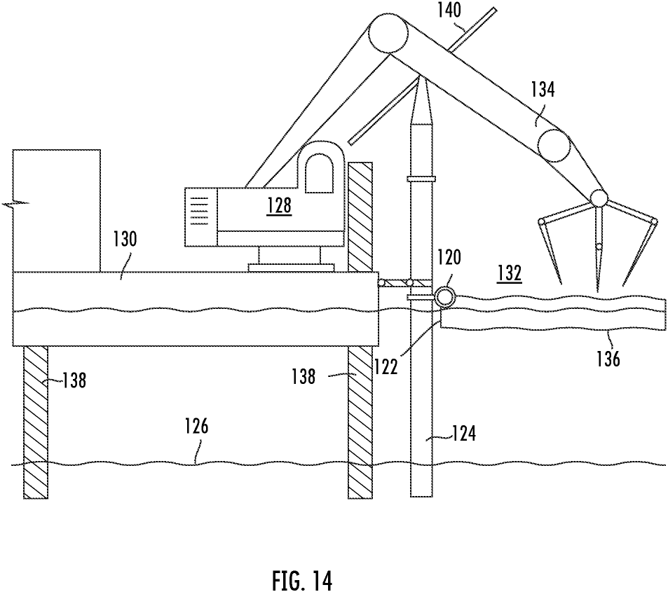

FIG. 14 illustrates yet another embodiment of a seaweed farming system using a static harvesting method. In this embodiment, floating boom 120 with attached mesh skirt 122 may be secured to piling 124, which has a lower end secured to sea bed or lake bed 126. Pilings 124 may be formed of wooden or concrete pilings. The static harvesting system includes excavator 128 may be positioned on platform 130 near enclosed area 132. Excavator arm 134 of excavator 128 may be configured to reach into enclosed area 132 and grab seaweed crop 136. In other embodiments, an electric powered harvester device may be used to reach into enclosed area 132 and grab seaweed crop 136. Seaweed processing equipment and storage containers may also be positioned on platform 130. Platform 130 may be supported by pilings 138 and configured to be raised or lowered along pilings 138. Pilings 138 may be formed of steel barge pilings. Optionally, solar panel 140 may be secured to an upper end of piling 124 for providing electricity to power sensors, navigation lights, and the harvester.

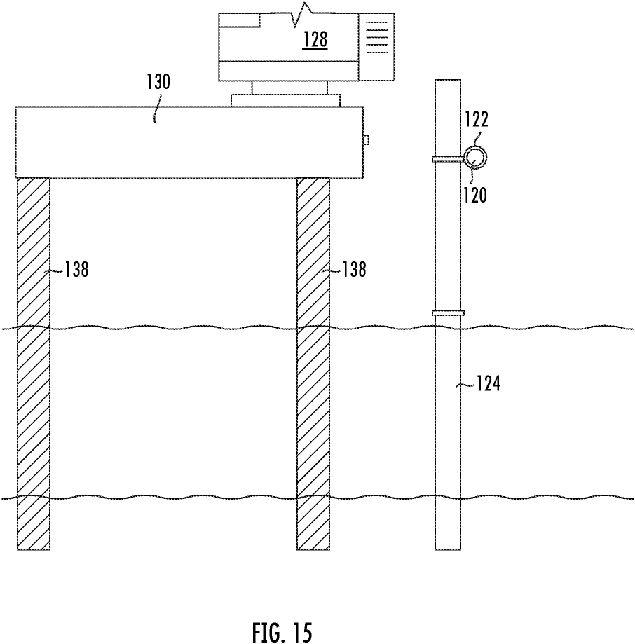

FIG. 15 illustrates the same embodiment of the seaweed farming system and the static harvesting system, as shown in FIG. 14, in a storm position. In this position, platform 130 is lifted out of the water on pilings 138. Additionally, floating boom 120 is lifted out of the water on piling 124 with mesh skirt 122 wrapped around floating boom 120.

In other embodiments, mobile harvesting systems may be used. For example, a mobile harvester may move along a system of rails or cables positioned along a perimeter of pilings that support the floating boom enclosure of the seaweed farming system. In certain embodiments, the movement of the harvester on the rails or cables may be powered by renewable energy sources (e.g., solar, wind, or hydrogen), with the renewable energy systems positioned on the harvester or on the piling structures. These mobile harvesters may move in a preset path (e.g., clockwise around the perimeter of the enclosure) to harvest the seaweed or aquatic plants building up beside the floating boom. Alternatively, the mobile harvesters may be controlled by an operator, who may be present at the harvesting location or who may be remotely controlling the mobile harvesters.

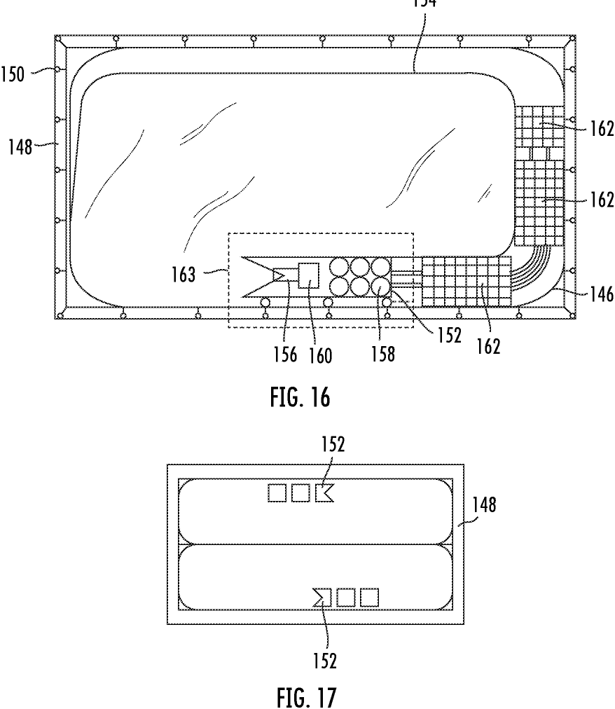

FIG. 16 illustrates one embodiment of a mobile harvesting system for a seaweed farming system. In this embodiment, a cable or rail pulley system 146 is configured around the enclosed area defined by the floating booms 148 with attached mesh skirts. Floating booms 148 may be secured to an outer edge of piling 150, thereby enabling the raising of the floating booms 148 during a storm on pilings 150. A harvester vessel 152 is pulled along the cable or rail pulley system 146 to harvest the seaweed 154 present along the internal perimeter of the enclosed area. A conveyer belt 156 in communication with the floating seaweed 154 may be positioned at a forward end of the harvester vessel 152. The harvester vessel 152 may also include storage tanks 158 and/or seaweed processing equipment, such as crusher 160. Optionally, the harvester vessel 152 may pull a series of vessels or barges 162 containing solar panels configured to power the movement of the harvester vessel 152 along the cable or rail pulley system 146. In certain embodiments, the harvester vessel includes one or more solar panels 163 on its roof.

In a related embodiment illustrated in FIG. 17, the cable or rail system 146 may be configured to subdivide the enclosed area within the floating booms 148 into two or more sections, with a harvesting vessel 152 moving along a perimeter of each of the subdivided sections. After the harvesting vessel 152 removes the seaweed from an area of the enclosure and passes the area, the seaweed growth expands into the free water space left behind. The harvesting vessel 152 collects this seaweed regrowth upon its next round of movement around the inner perimeter of the enclosed area.

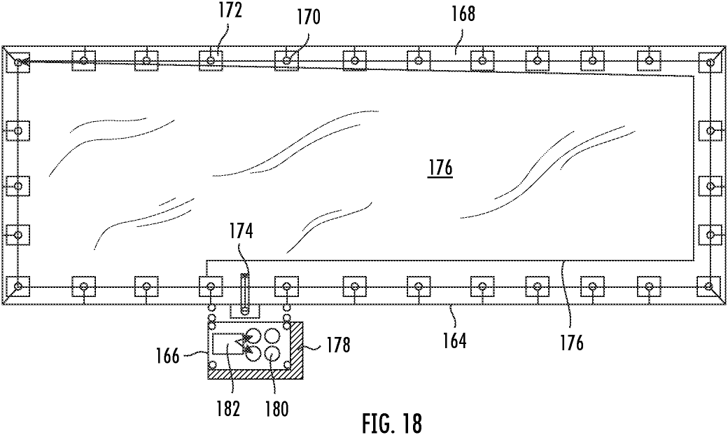

FIG. 18 illustrates another embodiment of a mobile harvesting system for a floating seaweed farming system. In this embodiment, the cable or rail system 164 pulls a harvesting vessel 166 along an outer perimeter of the enclosed area defined by floating booms 168. In this embodiment, the floating booms 168 may be supported by pilings 170, which optionally each includes a solar panel 172. The harvesting vessel 166 may include a harvesting extension 174 that collects the seaweed crop 176 from within the enclosed area and pulls the seaweed crop 176 onto the harvesting vessel 166. For example, the harvesting vessel 166 may include a grabbing arm to pull the seaweed crop from the enclosed area into the harvesting vessel. Alternatively, the harvesting vessel 166 may include a conveyor belt extending into the enclosed area. Solar panels 178 may be connected to the harvesting vessel 166 and configured to power the movement of the harvesting vessel 166 along the rail or cable system 164. The harvesting vessel 166 may also contain storage 180 and/or seaweed processing components 182. After the harvesting extension 174 of harvesting vessel 166 removes the seaweed 176 from an area in the enclosure and passes the area, the seaweed growth expands into the free water space left behind. The harvesting extension 174 of the harvesting vessel 166 collects this seaweed regrowth upon its next round of movement around the inner perimeter of the enclosed area.

Mobile harvesting systems may also include harvesting devices configured to move independently in or around the floating boom enclosures without being attached to a cable or rail. These independent mobile harvesters may be controlled by an onboard operator, remotely operated, or robotically programed to access any seaweed within the enclosure. The independent mobile harvesters may be powered by renewable energy sources (e.g., solar, wind, or hydrogen). The renewable energy systems may be positioned on the mobile harvesters. Alternatively, the renewable energy systems may be positioned on pilings and the independent mobile harvesters may be configured to periodically connect to charging stations at the pilings.

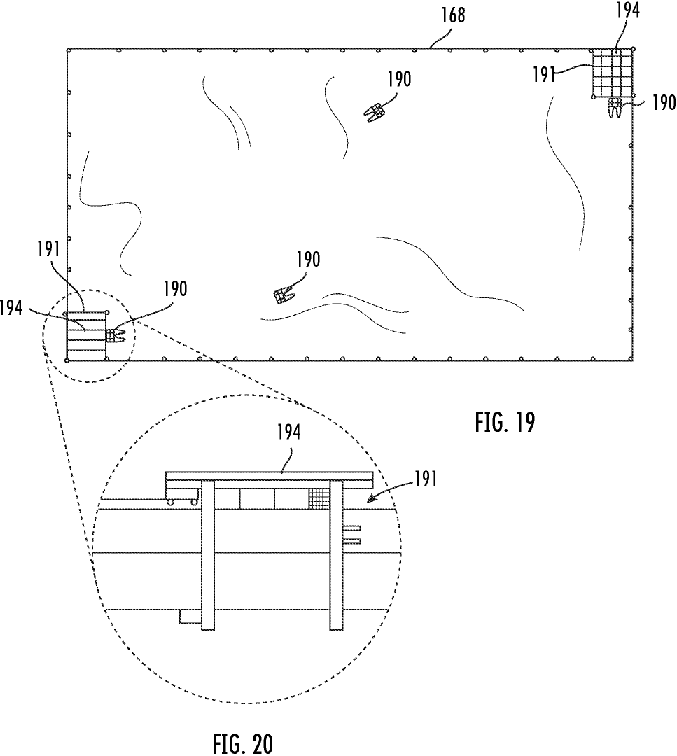

FIGS. 19 and 20 illustrate an embodiment of a floating seaweed farming system with independent mobile harvesting devices. It includes one or more harvester boats 190, each including harvesting components such as conveyor belts. Optionally, each harvester boat 190 may also include seaweed processing components and/or storage containers. A station 191 for each harvester boat 190 is secured to an outer edge of the enclosed area. Each harvester boat 190 may be configured to periodically return to its respective station 191 for charging by a solar panel and/or wind power system with battery energy storage located at the station and for unloading the harvested seaweed crop onto the station. The station may be configured to lift the harvester boats 190 out of the water during a storm.

Once the floating seaweed farming system disclosed herein is configured and secured in a location, seeds or a number of fragments or individuals of a target floating seaweed or target floating aquatic plant may be placed into the enclosed area. The seeds and/or seaweed/plant individuals then grow and begin to take up space in the enclosure. For example, certain seaweed species grow 5% per day. As the floating seaweed or floating plants grow, they take up an increasing amount of the water surface area within the enclosed area. Harvesting may begin at any point in time. In some embodiments, harvesting begins when the floating seaweed or floating plants fill the entirety or a majority of the water surface area within the enclosure. In certain embodiments, a daily harvesting rate is equal to the daily growth rate or the amount of the floating seaweed or floating plant that grows each day. In other embodiments, a larger amount of the floating seaweed or floating plant is harvested with a longer time interval before the next harvest to allow the floating seaweed or floating plant to regrow in the enclosure.

In some embodiments, seaweed processing systems may be integrated into the harvesting devices or integrated into the piling structure. Alternatively, seaweed processing systems may be positioned on site in line with or near the harvester. Additionally, storage tanks for liquid, pulp, dried, or wet seaweed product may be located on harvesters, on support vessels, or on structures integrated into the enclosure pilings. Enclosure piling structures may have secure, wind-resistant areas high above the water level to safely store the floating boom and mesh skirts or mesh panels or fencing in the event of a storm. Enclosure piling structures may also integrate renewable energy production and storage devices, such as small wind turbines or solar panels and associated batteries for energy storage. These renewable energy devices may be used to power harvesting devices and processing devices. The renewable energy devices may also be used to power lights on the floating seaweed farm enclosure. For example, the lights may mark the boundaries of the enclosure at night.

To maximize freshness and recovery of nutrients, seaweed biomass can be crushed or squeezed immediately after harvesting. In this process, separate streams of liquid and solid pulp products may be collected for use in different products, such as fertilizer, feed, fiber, or fuel. Additionally, the seaweed product may be dried using driers and formed into bales, pellets, or other shapes.

During storms, pilings may be used to lift harvesters and other components, such as storage tanks, above the water level to prevent damage to these devices.

In certain embodiments, algae, seaweed, and any other biomass growth attached to the floating boom and mesh may be collected and harvested. This collection serves to maintain and clean off the equipment while increasing the harvest yield of biomass.

A method of farming seaweed includes positioning a floating enclosure defined by one or more floating booms with attached mesh skirts in a water body and securing the floating enclosure in a location using an anchor system or a piling system. In calm waters (i.e., low wind and wave action) with insignificant water level changes, mesh panels without a buoy or boom strung between pilings at the water surface is another option to enclose and farm the floating seaweed. A floating seaweed or floating plant species is allowed to grow within the enclosure. The floating booms with attached mesh skirts contain the seaweed as it grows and the mesh skirts allow the seaweed to obtain nutrients from water flowing through the mesh skirts. The seaweed growth is harvested using a static harvesting system or a mobile harvesting system. The method may also include processing the harvested seaweed with a processing system positioned on or near the harvesting system. In certain embodiments, processing the harvested seaweed immediately or soon after harvesting the seaweed results in higher seaweed quality for use in commercial products because the seaweed is processed before significant decomposition occurs. The method may further include storing seaweed processing outputs, which may be liquid or solid components, on site and later transporting the outputs from the farming/harvesting/processing location.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. An element proceeded by “comprises ... a” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

Except as otherwise described or illustrated, each of the components in this device may be formed of aluminum, steel, another metal, plastic, or any other durable, natural or synthetic material. Each device described in this disclosure may include any combination of the described components, features, and/or functions of each of the individual device embodiments. Each method described in this disclosure may include any combination of the described steps in any order, including the absence of certain described steps and combinations of steps used in separate embodiments. Any range of numeric values disclosed herein includes any subrange therein. Plurality means two or more.

While preferred embodiments have been described, it is to be understood that the embodiments are illustrative only and that the scope of the invention is to be defined solely by the appended claims when accorded a full range of equivalents, many variations and modifications naturally occurring to those skilled in the art from a review hereof.

What is claimed is:

1. A system for farming and harvesting floating seaweed and floating aquatic plants, comprising:
a floating enclosed area positioned in a water body, the floating enclosed area defined by one or more floating booms, wherein a mesh skirt is attached to each floating boom; and
a harvesting system for collecting seaweed growing within the floating enclosed area.

2. The system of claim 1, wherein the harvesting system is static in relation to the floating enclosed area.

3. The system of claim 2, wherein the harvesting system includes a conveyor belt having a distal end positioned in the water within the floating enclosed area.

4. The system of claim 3, wherein the conveyor belt includes a plurality of teeth configured to engage the seaweed and pull the seaweed along a surface of the conveyor belt.

5. The system of claim 4, wherein the one or more floating booms each includes a spinning boom configured to engage the seaweed and direct the seaweed to the distal end of the conveyor belt.

6. The system of claim 2, wherein the harvesting system includes an excavator arm configured to lift the seaweed out of the floating enclosed area.

7. The system of claim 1, wherein the harvesting system is dynamic in relation to the floating enclosed area.

8. The system of claim 7, wherein the harvesting system includes a rail system within the floating enclosed area and a harvester vessel disposed within the floating enclosed area, wherein the harvester vessel is configured to move along the rail system to collect the seaweed from the floating enclosed area.

9. The system of claim 7, wherein the harvesting system includes a rail system along the outside of the floating enclosed area and a harvester vessel disposed outside of the floating enclosed area, wherein the harvester vessel is configured to move along the rail system to collect the seaweed from the floating enclosed area with a harvester extension disposed within the floating enclosed area.

10. The system of claim 7, wherein the harvesting system includes one or more harvester boats and a station for each harvester boat disposed within the floating enclosed area, wherein each harvester boat is configured to collect the seaweed from the floating enclosed area, and wherein each station is configured to collect the seaweed from the harvester boat and to charge the harvester boat.

11. The system of claim 1, further comprising a seaweed processing system disposed on a vessel with the harvesting system.

12. The system of claim 1, wherein the one or more floating booms are secured in a location within the water body by an anchor system configured to allow the one or more floating booms to continue floating at a variable water surface level.

13. The system of claim 1, wherein the one or more floating booms are secured in a location within the water body with pilings in a configuration that allows the one or more floating booms to continue floating at a variable water surface level.

14. The system of claim 1, further comprising a harvesting system for biomass growth on the floating boom with mesh skirt.

15. A system for farming and harvesting seaweed comprising:
an enclosed area positioned in a water body, the enclosed area defined by one or more mesh panels each secured to two or more pilings, wherein the one or more mesh panels extend across spaces between pilings; and
a harvesting system for collecting seaweed growth in the enclosed area.

16. A method of farming and harvesting seaweed, comprising the steps of:
a) providing a floating enclosed area secured in a location in a water body, the floating enclosed area defined by one or more floating booms, wherein a mesh skirt is attached to each floating boom;
b) growing a seaweed crop within the floating enclosed area;
c) harvesting the seaweed crop from the floating enclosed area with a harvesting system.

17. The method of claim 16, wherein the location is within a eutrophic water body.

18. The method of claim 16, further comprising:
d) processing the seaweed crop with a processing system disposed on a vessel, wherein the harvesting system is also disposed on the vessel.

19. The method of claim 16, wherein the water body has an elevated level of nutrients; wherein in step (b) the seaweed crop absorbs at least a portion of nutrients in the water body to reduce the elevated level of nutrients; wherein in step (c) the seaweed crop is processed before the seaweed crop decomposes to maximize seaweed product quality, remove nutrients from the water body, and clean the water body.

20. A method of farming and harvesting seaweed, comprising the steps of:
a) providing an enclosed area secured in a location in a water body, the enclosed area defined by one or more mesh panels secured to two or more pilings, wherein the one or more mesh panels extend across spaces between the pilings;
b) growing a seaweed crop within the enclosed area;
c) harvesting the seaweed crop from the enclosed area with a harvesting system.
